(19) United States
(12) Patent Application Publication
(10) Pub. No.: US 2016/0070117 A1
(43) Pub. Date: Mar. 10, 2016

(54) ELECTRO-ACTIVE OPHTHALMIC LENSES COMPRISING LOW VISCOSITY LIQUID CRYSTALLINE MIXTURES

(71) Applicant: Mitsui Chemicals, Inc., Tokyo (JP)

(72) Inventors: Anita TRAJKOVSKA-BROACH, Christiansburg, VA (US); Ronald D. BLUM, Roanoke, VA (US); William KOKONASKI, Gig Harbor, WA (US)

(21) Appl. No.: 14/941,348

(22) Filed: Nov. 13, 2015

Related U.S. Application Data
(63) Continuation of application No. 13/955,650, filed on Jul. 31, 2013, now abandoned.
(60) Provisional application No. 61/679,260, filed on Aug. 3, 2012.

(51) Int. Cl. G02C 7/08; G02C 7/06

(52) U.S. Cl. CPC G02C 7/083; G02C 7/061; G02C 2202/20

(57) ABSTRACT

An electro-active ophthalmic lens is presented in which the lens includes a progressive addition region having an add power and an electro-active element. The electro-active element is in optical communication with the progressive addition region and has an activated state and a deactivated state. The electro-active element also includes a liquid crystalline material disposed in a cavity having a diffractive surface relief structure. The liquid crystalline material has a low rotational viscosity.

### CROSS REFERENCE TO RELATED APPLICATIONS

This application is a continuation of U.S. application Ser. No. 13/955,650, filed Jul. 31, 2013, which claims the benefit of U.S. Provisional Appl. No. 61/679,260 filed on Aug. 3, 2012. These applications are hereby incorporated by reference in their entireties.

### BACKGROUND OF THE INVENTION

1. Field of the Invention

The present invention relates to electro-active ophthalmic lenses, lens designs, lens systems, and eyewear products or devices utilized on, in, or about the eye having a liquid crystalline mixture with a low rotational viscosity.

2. Background

Presbyopia is the loss of accommodation of the crystalline lens of the human eye that often accompanies aging. This loss of accommodation results in an inability to focus on near distance objects. The standard tools for correcting presbyopia are multifocal ophthalmic lenses. A multifocal lens is a lens that has more than one focal length (i.e., optical power) for correcting focusing problems across a range of distances. Multifocal ophthalmic lenses work by means of a division of the lens's area into regions of different optical powers. Typically, a relatively large area located in the upper portion of the lens corrects for far distance vision errors, if any. A small area located in the bottom portion of the lens provides additional optical power for correcting near distance vision errors caused by presbyopia. A multifocal lens can also contain a small region located near the middle portion of the lens which provides additional optical power for correcting intermediate distance vision errors.

The transition between the regions of different optical power can be either abrupt, as is the case for bifocal and trifocal lenses, or smooth and continuous, as is the case with Progressive Addition Lenses. Progressive Addition Lenses are a type of multifocal lenses that comprise a gradient of continuously increasing positive dioptric optical power from the beginning of the far distance viewing zone of the lens to the near distance viewing zone in the lower portion of the lens. This progression of optical power generally starts at approximately what is known as the fitting cross or fitting point of the lens and continues until the full add power is realized in the near distance viewing zone and then plateaus. Conventional and state-of-the-art Progressive Addition Lenses utilize a surface topography on one or both exterior surfaces of the lens shaped to create this progression of optical power. Progressive Addition Lenses are known within the optical industry when plural as PALS or when singular, as a PAL. PAL lenses are advantageous over traditional bifocal and trifocal lenses in that they can provide a user with a lineless, cosmetically pleasing multifocal lens with continuous vision correction when focusing on objects at a far distance to objects at a near distance or vice versa.

While PALs are now widely accepted and in vogue within the USA and throughout the world as a correction for presbyopia, they also have serious vision compromises. These compromises include but are not limited to unwanted astigmatism, distortion, and perceptual blur. These vision compromises can affect a user's horizontal viewing width, which is the width of the visual field that can be seen clearly as a user looks from side to side while focused at a given distance. Thus, PAL lenses can have a narrow horizontal viewing width when focusing at an intermediate distance, which can make viewing a large section of a computer screen difficult. Similarly, PAL lenses can have a narrow horizontal viewing width when focusing at a near distance, which can make viewing the complete page of a book or newspaper difficult. Far distance vision can be similarly affected. PAL lenses can also present a difficulty to a wearer when playing sports due to the distortion of the lenses. Additionally, because the optical add power is placed in the bottom region of the PAL lens, the wearer must tilt his or her head back to make use of this region when viewing an object above his or her head which is located at a near or intermediate distance. Contrastingly, when a wearer is descending stairs and assumes a downward glance, a near distance focus is provided by the lens instead of the far distance focus necessary to see one's feet and the stairs clearly. Thus, the wearer's feet will be out of focus and appear blurred. In addition to these limitations, many wearers of PALs experience an unpleasant effect known as visual motion (often referred to as “swim”) due to the unbalanced distortion that exists in each of the lenses. In fact, many people refuse to wear such lenses because of this effect.

When considering the near optical power needs of a presbyopic individual, the amount of near optical power required is directly related to the amount of accommodative amplitude (near distance focusing ability) the individual has left in his or eyes. Generally, as an individual ages the amount of accommodative amplitude decreases. Accommodative amplitude can also decrease for various health reasons. Therefore, as one ages and becomes more presbyopic, the optical power needed to correct one's ability to focus at a near viewing distance and an intermediate viewing distance becomes stronger in terms of the needed dioptric optical add power. By way of example only, an individual 45 years old may need +1.00 diopters of near viewing distance optical power to see clearly at a near point distance, while an individual 80 years old may need +2.75 diopters to +3.00 diopters of near viewing distance optical power to see clearly at the same near point distance. Because the degree of vision compromises in PAL lenses increases with dioptric optical add power, a more highly presbyopic individual will be subject to greater vision compromises. In the example above, the individual who is 45 years of age will have a lower level of distortion associated with his or her lenses than the individual who is 80 years of age. As is readily apparent, this is the complete opposite of what is needed given the quality of life issues associated with being elderly, such as frailty or loss of dexterity. Prescription multifocal lenses that add compromises to vision function and inhibit safety are in sharp contrast to lenses that make lives easier, safer, and less complex.

By way of example only, a conventional PAL with a +1.00D near optical power can have approximately +1.00D or less of unwanted astigmatism. However, a conventional PAL with a +2.50D near optical power can have approximately +2.75D or more of unwanted astigmatism while a conventional PAL with a +3.25D near point optical power can have approximately +3.75D or more of unwanted astigmatism. Thus, as a PAL's near distance add power increases (for example, a +2.50D PAL compared to a +1.00D PAL), the unwanted astigmatism found within the PAL increases at a greater than linear rate with respect to the near distance add power.

More recently, a double-sided PAL has been developed which has a progressive addition surface topography placed on each side of the lens. The two progressive addition surfaces are aligned and rotated relative to one another to not only give the appropriate total additive near distance add power required, but also to have the unwanted astigmatism created by the PAL on one surface of the lens counteract some of the unwanted astigmatism created by the PAL on the other surface of the lens. Even though this design somewhat reduces the unwanted astigmatism and distortion for a given near distance add power as compared to traditional PAL lenses, the level of unwanted astigmatism, distortion and other vision compromises listed above still causes serious vision problems for the wearer.

Therefore, there is a pressing need to provide a spectacle lens and/or eyewear system that satisfies the vanity needs of presbyopic individuals and at the same time corrects their presbyopia in a manner that reduces distortion and blur, widens the horizontal viewing width, allows for improved safety, and allows for improved visual ability when playing sports, working on a computer, and reading a book or newspaper.

### BRIEF SUMMARY OF THE INVENTION

Some embodiments of the present invention provide a device including a lens having a progressive addition region with an add power and an electro-active element in optical communication with the progressive addition region. The electro-active element has an activated state and a deactivated state. The electro-active element also includes a liquid crystalline material disposed in a cavity having a diffractive surface relief structure. The liquid crystalline material has a first average index of refraction when the electro-active element is in the activated state and a second average index of refraction, different from the first average index of refraction, when the electro-active element is in the deactivated state. A preferred depth of the diffractive surface relief structure is from 1 micron to 10 microns. The diffractive surface relief structure has a preferred average index of refraction from 1.5 to 2. The liquid crystalline material has a preferred rotational viscosity of 50 mPa·s or less.

In some embodiments, the liquid crystalline material also has one or more of the following parameters: a dielectric anisotropy of 10 or higher, a haze clearing time of 600 msec or less, a switching time of 5 msec or less, switches at an applied voltage of 8 V or less, and a static haze of 1.3% or less.

In some embodiments, the second average index of refraction of the liquid crystalline material is substantially the same as the average index of refraction of the diffractive surface relief structure.

In some embodiments, the electro-active element further includes a first substrate having the diffractive surface relief structure and a second substrate.

In some embodiments, at least the diffractive surface relief structure of the first substrate and the second substrate define a shape of the cavity.

In some embodiments, the electro-active element further includes a first electrode disposed between the first substrate and the liquid crystalline material and a second electrode disposed between the second substrate and the liquid crystalline material. In some embodiments, the electro-active element further includes an insulation layer between the first and second electrodes. In some embodiments, the electro-active element further includes an alignment layer disposed on at least one of the first and second electrodes.

In some embodiments, the average index of refraction of the diffractive surface relief structure is from 1.5 to 1.8.

In some embodiments, the device is a pair of spectacles.

### BRIEF DESCRIPTION OF THE DRAWINGS/FIGURES

The accompanying drawings, which are incorporated herein and form a part of the specification, illustrate embodiments of the present invention and, together with the description, further serve to explain the principles of the invention and to enable a person skilled in the pertinent art to make and use the invention.

FIG. 1A shows an embodiment of a low add power Progressive Addition Lens having a fitting point and a progressive addition region;

FIG. 1B shows a graph of optical power 130 taken along a cross section of the lens of FIG. 1A, along axis line AA;

FIG. 2A shows an embodiment of the invention having a low add power Progressive Addition Lens combined with a much larger dynamic optic placed such that a portion of the dynamic optic lies above a fitting point of the lens;

FIG. 2B shows the combined lens of FIG. 2A having a combined optical power that is created because the dynamic optic is in optical communication with a progressive addition region;

FIG. 3A shows an embodiment of the invention having a low add power Progressive Addition Lens and a dynamic optic placed such that a portion of the dynamic optic lies above a fitting point of the lens, FIG. 3A shows when the dynamic optic is deactivated, the optical power taken along a line of sight from a wearer's eye through the fitting point provides the wearer with correct far distance vision;

FIG. 3B shows the lens of FIG. 3A. FIG. 3B shows when the dynamic optic is activated, the optical power taken along a line of sight from the wearer's eye through the fitting point provides the wearer with a correct intermediate distance focusing power;

FIG. 3C shows the lens of FIG. 3A. FIG. 3C shows when the dynamic optic is activated, the optical power taken along a line of sight from the wearer's eye through the near distance viewing zone provides the wearer with a correct neat distance focusing power;

FIG. 4A shows an embodiment of the invention having a low add power Progressive Addition Lens combined with a dynamic optic that is larger than a progressive addition region and/or channel and located above a fitting point of the lens;

FIG. 4B shows the optical power that is provided by the fixed progressive addition surface or region taken along axis line AA of FIG. 4A;

FIG. 4C shows the optical power that is provided by the dynamic optic when activated taken along axis line AA of FIG. 4A;

FIG. 4D shows the combined powers of the dynamic electro-active optic and the fixed progressive addition region taken along axis line AA of FIG. 4A. FIG. 4D shows that the top and bottom distorted blend area of the dynamic electro-active optic are outside both the fitting point and the progressive addition reading area and channel;

FIG. 5A shows an embodiment of the invention in which a dynamic optic is located below a fitting point of a low add power Progressive Addition Lens;

FIG. 5B shows optical power, taken along axis line AA of FIG. 5A;

FIGS. 6A-6C show various embodiments of the size of the dynamic optic;

FIG. 7 shows an exemplary cross-sectional view of an electro-active element; and

FIG. 8 shows an exploded cross-sectional view of an exemplary electro-active lens.

### DETAILED DESCRIPTION OF THE INVENTION

Many ophthalmological, optometric, and optical terms are used in this application. For the sake of clarity, their definitions are listed below:

Add Power: The optical power added to the far distance viewing optical power which is required for clear near distance viewing in a multifocal lens. For example, if an individual has a far distance viewing prescription of −3.00D with a +2.00D add power for near distance viewing then the actual optical power in the near distance portion of the multifocal lens is −1.00D. Add power is sometimes referred to as plus power. Add power can be further distinguished by referring to “near viewing distance add power” which refers to the add power in the near viewing distance portion of the lens and “intermediate viewing distance add power” which refers to the add power in the intermediate viewing distance portion of the lens. Typically, the intermediate viewing distance add power is approximately 50% of the near viewing distance add power. Thus, in the example above, the individual would have +1.00D add power for intermediate distance viewing and the actual total optical power in the intermediate viewing distance portion of the multifocal lens is −2.00D.

Approximately: Plus or minus 10 percent, inclusive. Thus, the phrase “approximately 10 mm” can be understood to mean from 9 mm to 11 mm, inclusive.

Blend Zone: An optical power transition along a peripheral edge of a lens whereby the optical power continuously transitions across the blend zone from a first corrective power, to that of a second corrective power or vice versa. Generally the blend zone is designed to have as small a width as possible. A peripheral edge of a dynamic optic can include a blend zone so as to reduce the visibility of the dynamic optic. A blend zone is utilized for cosmetic enhancement reasons and also to enhance vision functionality. A blend zone is typically not considered a usable portion of the lens due to its high unwanted astigmatism. A blend zone is also known as a transition zone.

Channel: The region of a Progressive Addition Lens defined by increasing plus optical power which extends from the far distance optical power region or zone to the near distance optical power region or zone. This optical power progression starts in an area of the PAL known as the fitting point and ends in the near distance viewing zone. The channel is sometimes referred to as the corridor.

Channel Length: The channel length is the distance measured from the fitting point to the location in the channel where the add power is within approximately 85% of the specified near distance viewing power.

Channel Width: The narrowest portion of the channel bounded by an unwanted astigmatism that is above approximately +1.00D. This definition is useful when comparing PAL lenses due to the fact that a wider channel width generally correlates with less distortion, better visual performance, increased visual comfort, and easier adaptation for the wearer.

Conventional Channel Length: Due to aesthetic concerns or trends in eyewear fashion, it can be desirable to have a lens that is foreshortened vertically. In such a lens the channel is naturally also shorter. Conventional channel length refers to the length of a channel in a non-foreshortened PAL lens. These channel lengths are usually, but not always, approximately 15 mm or longer. Generally, a longer channel length means a wider channel width and less unwanted astigmatism. Longer channel designs are often associated with “soft” progressives, since the transition between far distance correction and near distance correction is softer due to the more gradual increase in optical power.

Dynamic lens: A lens with an optical power which is alterable with the application of electrical energy, mechanical energy or force. Either the entire lens can have an alterable optical power, or only a portion, region or zone of the lens can have an alterable optical power. The optical power of such a lens is dynamic or tunable such that the optical power can be switched between two or more optical powers. One of the optical powers can be that of substantially no optical power. Examples of dynamic lenses include electro-active lenses, meniscus lenses, fluid lenses, movable dynamic optics having one or more components, gas lenses, and membrane lenses having a member capable of being deformed. A dynamic lens can also be referred to as a dynamic optic, a dynamic optical element, a dynamic optical zone or a dynamic optical region.

Electro-active lens: An electro-active lens is a type of dynamic lens wherein the optical power is switched by applying a voltage to the lens. Liquid crystal can be placed in a cavity between two electrodes and the refractive index of a liquid crystal can be changed by generating an electric field across the liquid crystal. Such an electric field can be generated by applying one or more voltages to electrodes located on both sides of the liquid crystal whereby various optical powers can be created in the lens depending on the types of electrodes used, voltages applied to the electrodes and index of refraction altered within a thin layer of liquid crystal. The cavity shape can be refractive or diffractive.

Far Distance Reference Point: A reference point located approximately 3-4 mm above the fitting cross where the far distance prescription or far, distance optical power of the lens can be measured easily.

Far Distance Viewing Zone: The portion of a lens containing an optical power which allows a user to see correctly at a far viewing distance.

Far Distance Width: The narrowest horizontal width within the far distance viewing portion of the lens which provides clear, mostly distortion-face correction with an optical power within 0.25D of the wearer's far distance viewing optical power correction.

Far Viewing Distance: The distance to which one looks, by way of example only, when viewing beyond the edge of one's desk, when driving a car, when looking at a distant mountain, or when watching a movie. This distance is usually, but not always, considered to be approximately 32 inches or greater from the eye. The far viewing distance can also be referred to as a far distance and a far distance point.

Fitting Cross/Fitting Point: A reference point on a PAL that represents the approximate location of the wearer's pupil when looking straight ahead through the lens once the lens is mounted in an eyeglass frame and positioned on the wearer's face. The fitting cross/fitting point is usually, but not always, located 2-5 mm vertically above the start of the channel. The fitting cross typically has a very slight amount of plus optical power ranging from just over +0.00 Diopters to approximately +0.12 Diopters. This point or cross is marked on the lens surface such that it can provide an easy reference point for measuring and/or double-checking the fitting of the lens relative to the pupil of the wearer. The mark is easily removed upon the dispensing of the lens to the patient/wearer.

Hard Progressive Addition Lens: A Progressive Addition Lens with a less gradual, steeper transition between the far distance correction and the near distance correction. In a hard PAL the unwanted distortion can be below the fitting point and not spread out into the periphery of the lens. A hard PAL can also have a shorter channel length and a narrower channel width. A “modified hard Progressive Addition Lens” is a hard PAL which is modified to have a limited number of characteristics of a soft PAL such as a more gradual optical power transition, a longer channel, a wider channel, more unwanted astigmatism spread out into the periphery of the lens, and less unwanted astigmatism below the fitting point.

Intermediate Distance Viewing Zone: The portion of a lens containing an optical power which allows a user to see correctly at an intermediate viewing distance.

Intermediate Viewing Distance: The distance to which one looks, by way of example only, when reading a newspaper, when working on a computer, when washing dishes in a sink, or when ironing clothing. This distance is usually, but not always, considered to be between approximately 16 inches and approximately 32 inches from the eye. The intermediate viewing distance can also be referred to as an intermediate distance and an intermediate distance point.

Lens: Any device or portion of a device that causes light to converge or diverge. The device can be static or dynamic. A lens can be refractive or diffractive. A lens can be either concave, convex or plano on one or both surfaces. A lens can be spherical, cylindrical, prismatic or a combination thereof. A lens can be made of optical glass, plastic or resin. A lens can also be referred to as an optical element, an optical zone, an optical region, an optical power region or an optic. It should be pointed out that within the optical industry a lens can be referred to as a lens even if it has zero optical power.

Lens Blank: A device made of optical material that can be shaped into a lens. A lens blank can be finished meaning that the lens blank has been shaped to have an optical power on both external surfaces. A lens blank can be semi-finished meaning that the lens blank has been shaped to have an optical power on only one external surface. A lens blank can be unfinished meaning that the lens blank has not been shaped to have an optical power on either external surface. A surface of an unfinished or semi-finished lens blank can be finished by means of a fabrication process known as free-forming or by more traditional surfacing and polishing.

Low Add Power PAL: A Progressive Addition Lens that has less than the necessary near add power for the wearer to see clearly at a near distance.

Multifocal Lens: A lens having more than one focal point or optical power. Such lenses can be static or dynamic. Examples of static multifocal lenses include a bifocal lens, trifocal lens or a Progressive Addition Lens. Examples of dynamic multifocal lenses include electro-active lenses whereby various optical powers can be created in the lens depending on the types of electrodes used, voltages applied to the electrodes and index of refraction altered within a thin layer of liquid crystal. Multifocal lenses can also be a combination of static and dynamic. For example, an electro-active element can be used in optical communication with a static spherical lens, static single vision lens, static multifocal lens such as, by way of example only, a Progressive Addition Lens. In most, but not all, cases, multifocal lenses are refractive lenses.

Near Distance Viewing Zone: The portion of a lens containing an optical power which allows a user to see correctly at a near viewing distance.

Near Viewing Distance: The distance to which one looks, by way of example only, when reading a book, when threading a needle, or when reading instructions on a pill bottle. This distance is usually, but not always, considered to be between approximately 12 inches and approximately 16 inches from the eye. The near viewing distance can also be referred to as a near distance and a near distance point.

Office Lens/Office PAL: A specially designed Progressive Addition Lens that provides intermediate distance vision above the fitting cross, a wider channel width and also a wider reading width. This is accomplished by means of an optical design which spreads the unwanted astigmatism above the fitting cross and which replaces the far distance vision zone with that of a mostly intermediate distance vision zone. Because of these features, this type of PAL is well-suited for desk work, but one cannot drive his or her car or use it for walking around the office or home since the lens contains no far distance viewing area.

Ophthalmic Lens: A lens suitable for vision correction which includes a spectacle lens, a contact lens, an intra-ocular lens, a corneal in-lay, and a corneal on-lay.

Optical Communication: The condition whereby two or more optics of given optical power are aligned in a manner such that light passing through the aligned optics experiences a combined optical power equal to the sum of the optical powers of the individual elements.

Patterned Electrodes: Electrodes utilized in an electro-active lens such that with the application of appropriate voltages to the electrodes, the optical power created by the liquid crystal is created diffractively regardless of the size, shape, and arrangement of the electrodes. For example, a diffractive optical effect can be dynamically produced within the liquid crystal by using concentric ring shaped electrodes.

Pixilated Electrodes: Electrodes utilized in an electro-active lens that are individually addressable regardless of the size, shape, and arrangement of the electrodes. Furthermore, because the electrodes are individually addressable, any arbitrary pattern of voltages can be applied to the electrodes. For example, pixilated electrodes can be squares or rectangles arranged in a Cartesian array or hexagons arranged in a hexagonal array. Pixilated electrodes need not be regular shapes that fit to a grid. For example, pixilated electrodes can be concentric rings if every ring is individually addressable. Concentric pixilated electrodes can be individually addressed to create a diffractive optical effect.

Progressive Addition Region: A region of a lens having a first optical power in a first portion of the region and a second optical power in a second portion of the region wherein a continuous change in optical power exists therebetween. For example, a region of a lens can have a far viewing distance optical power at one end of the region. The optical power can continuously increase in plus power across the region, to an intermediate viewing distance optical power and then to a near viewing distance optical power at the opposite end of the region. After the optical power has reached a near-viewing distance optical power, the optical power can decrease in such a way that the optical power of this progressive addition region transitions back into the far viewing distance optical power. A progressive addition region can be on a surface of a lens or embedded within a lens. When a progressive addition region is on the surface and comprises a surface topography it is known as a progressive addition surface.

Reading Width: The narrowest horizontal width within the near distance viewing portion of the lens which provides clear, mostly distortion free correction with an optical power within 0.25D of the wearer's near distance viewing optical power correction.

Short Channel Length: Due to aesthetic concerns or trends in eyewear fashion, it can be desirable to have a lens that is foreshortened vertically. In such a lens the channel is naturally also shorter. Short channel length refers to the length of a channel in a foreshortened PAL lens. These channel lengths are usually, but not always between approximately 11 mm and approximately 15 mm. Generally, a shorter channel length means a narrower channel width and more unwanted astigmatism. Shorter channel designs are often associated with “hard” progressives, since the transition between far distance correction and near distance correction is harder due to the steeper increase in optical power.

Soft Progressive Addition Lens: A Progressive Addition Lens with a more gradual transition between the far distance correction and the near distance correction. In a soft PAL the unwanted distortion can be above the fitting point and spread out into the periphery of the lens. A soft PAL can also have a longer channel length and a wider channel width. A “modified soft Progressive Addition Lens” is a soft PAL which is modified to have a limited number of characteristics of a hard PAL such as a steeper optical power transition, a shorter channel, a narrower channel, more unwanted astigmatism pushed into the viewing portion of the lens, and more unwanted astigmatism below the fitting point.

Static Lens: A lens having an optical power which is not alterable with the application of electrical energy, mechanical energy or force. Examples of static lenses include spherical lenses, cylindrical lenses, Progressive Addition Lenses, bifocals, and trifocals. A static lens can also be referred to as a fixed lens.

Unwanted Astigmatism: Unwanted aberrations, distortions or astigmatism found within a Progressive Addition Lens that are not part of the patient's prescribed vision correction, but rather are inherent in the optical design of a PAL due to the smooth gradient of optical power between the viewing zones. Although, a lens can have unwanted astigmatism across different areas of the lens of various dioptric powers, the unwanted astigmatism in the lens generally refers to the maximum unwanted astigmatism that is found in the lens. Unwanted astigmatism can also refer to the unwanted astigmatism located within a specific portion of a lens as opposed to the lens as a whole. In such a case qualifying language is used to indicate that only the unwanted astigmatism within the specific portion of the lens is being considered.

When describing dynamic lenses, the invention contemplates, by way of example only, electro-active lenses, fluid lenses, gas lenses, membrane lenses, and mechanical movable lenses, etc. Examples of such lenses can be found in Blum et al. U.S. Pat. Nos. 6,517,203, 6,491,394, 6,619,799, Epstein and Kurtin U.S. Pat. Nos. 7,008,054, 6,040,947, 5,668,620, 5,999,328, 5,956,183, 6,893,124, Silver U.S. Pat. Nos. 4,890,903, 6,069,742, 7,085,065, 6,188,525, 6,618,208, Stoner U.S. Pat. No. 5,182,585, and Quaglia U.S. Pat. No. 5,229,885.

It is well known and accepted within the optical industry that as long as the unwanted astigmatism and distortion of a lens is approximately 1.00D or less, the user of the lens, in most cases, will barely notice it. The invention disclosed herein relates to embodiments of an optical design, lens, and eyewear system that solve many, if not most, of the problems associated with PALs. In addition, the invention disclosed herein significantly removes most of the vision compromises associated with PALs. The invention provides a means of achieving the proper far, intermediate and near distance optical powers for the wearer while providing continuous focusing ability for various distances, similar to that of a PAL. But the invention at the same time keeps the unwanted astigmatism to a maximum of approximately 1.50D for certain high add power prescriptions such as a +3.00D, +3.25D and +3.50D. However, in most cases, the invention keeps the unwanted astigmatism to a maximum of approximately 1.00D or less.

The invention is based upon aligning a low add power PAL with a dynamic lens such that the dynamic lens and the low add power PAL are in optical communication, whereby the dynamic lens provides the additional needed optical power for the wearer to see clearly at a near distance. This combination leads to the unexpected result that not only does the wearer have the ability to see clearly at intermediate and near distances, but the level of unwanted astigmatism, distortion, and vision compromise are reduced significantly.

The dynamic lens can be an electro-active element. In an electro-active lens, an electro-active optic can be embedded within or attached to a surface of an optical substrate. The optical substrate can be a finished, semi-finished or unfinished lens blank. When a semi-finished or unfinished lens blank is used, the lens blank can be finished during manufacturing of the lens to have one or more optical powers. An electro-active optic can also be embedded within or attached to a surface of a conventional optical lens. The conventional optical lens can be a single focus lens or a multifocal lens such as a Progressive Addition Lens or a bifocal or trifocal lens. The electro-active optic can be located in the entire viewing area of the electro-active lens or in just a portion thereof. The electro-active optic can be spaced from the peripheral edge of the optical substrate for edging the electro-active lens for spectacles. The electro-active element can be located near the top, middle or bottom portion of the lens. When substantially no voltage is applied, the electro-active optic can be in a deactivated state in which it provides substantially no optical power. In other words, when substantially no voltage is applied, the electro-active optic can have substantially the same refractive index as the optical substrate or conventional lens in which it is embedded or attached. Two indices of refraction are considered to be substantially the same when they are within 0.03 of each other. When voltage is applied, the electro-active optic can be in an activated state in which it provides optical add power. In other words, when voltage is applied, the electro-active optic can have a different refractive index than the optical substrate or conventional lens in which it is embedded or attached.

Electro-active lenses can be used to correct for conventional or non-conventional errors of the eye. The correction can be created by the electro-active element, the optical substrate or conventional optical lens or by a combination of the two. Conventional errors of the eye include low order aberrations such as near-sightedness, far-sightedness, presbyopia, and astigmatism. Non-conventional errors of the eye include higher-order aberrations that can be caused by ocular layer irregularities.

Liquid crystal can be used as a portion of the electro-active optic as the refractive index of a liquid crystal can be changed by generating an electric field across the liquid crystal. Such an electric field can be generated by applying one or more voltages to electrodes located on both sides of the liquid crystal. The electrodes can be substantially transparent and manufactured from substantially transparent conductive materials such as Indium Tin Oxide (ITO) or other such materials which are well-known in the art. Liquid crystal based electro-active optics can be particularly well suited for use as a portion of the electro-active optic since the liquid crystal can provide the required range of index change so as to provide optical add powers of piano to +3.00D or more. This range of optical add powers can be capable of correcting presbyopia in the majority of patients.

A thin layer of liquid crystal (for example, less than 10 microns) can be used to construct the electro-active optic. The thin layer of liquid crystal can be sandwiched between two transparent substrates. The two substrates can also be sealed along their peripheral edge such that the liquid crystal is sealed within the substrates in a substantially airtight manner. Layers of a transparent conductive material can be deposited on the inner surfaces of the two, mostly planar, transparent substrates. The conductive material can then be used as electrodes. When a thin layer is employed, the shape and size of the electrode(s) can be used to induce certain optical effects within the lens. The required operating voltages to be applied to these electrodes for such thin layers of liquid crystal can be quite low, typically less than 5 volts. Electrodes can be patterned. For example, a diffractive optical effect can be dynamically produced within the liquid crystal by using concentric ring shaped electrodes deposited on at least one of the substrates. Such an optical effect can produce an optical add power based upon the radii of the rings, the widths of the rings, and the range of voltages separately applied to the different rings. Electrodes can be pixilated. For example, pixilated electrodes can be squares or rectangles arranged in a Cartesian array or hexagons arranged in a hexagonal array. Such an array of pixilated electrodes can be used to generate optical add powers by emulating a diffractive, concentric ring electrode structure. Pixilated electrodes can also be used to correct for higher-order aberrations of the eye in a manner similar to that used for correcting atmospheric turbulence effects in ground-based astronomy.

Current manufacturing processes limit the minimum pixel size, and as such limit the maximum dynamic electro-active optic diameter. By way of example only, when using a concentric pixilated approach that creates a diffractive pattern the maximum dynamic electro-active optic diameters are estimated to be 20 mm for +1.50D, 24 mm for +1.25.D, and 30 mm for +1.50D. Current manufacturing processes limit the maximum dynamic electro-active optic diameter when using a pixilated diffractive approach. As such, embodiments of the invention can possess dynamic electro-active optics with smaller optical powers at much larger diameters.

Alternately, the electro-active optic is comprised of two transparent substrates and a layer of liquid crystal, where the first substrate is mostly planar and coated with a transparent, conductive layer while the second substrate has a patterned surface that is of a surface relief diffractive pattern (also referred to as a diffractive surface relief structure) and is also coated with a transparent, conductive layer. A surface relief diffractive optic is a physical substrate which has a diffractive grating etched or created thereon. Surface relief diffractive patterns can be created by way of diamond turning, injection molding, casting, thermoforming, and stamping. Such an optic can be designed to have a fixed optical power and/or aberration correction. By applying voltage to the liquid crystal through the electrode, the optical power/aberration correction can be switched on and off by means of refractive index mismatching and matching, respectively. When substantially no voltage is applied, the liquid crystal can have substantially the same refractive index as the surface relief diffractive optic. This cancels out the optical power that would normally be provided by the surface relief diffractive element. When voltage is applied, the liquid crystal can have a different refractive index than the surface relief diffractive element such that the surface relief diffractive element now provides optical add power. By using a surface relief diffractive pattern approach dynamic electro-active optics having a large diameter or horizontal width can be made. The widths of these optics can be made up to or greater than 40 mm.

A thicker layer of liquid crystal (typically >50 microns) can also be used to construct the electro-active multifocal optic. For example, a modal lens can be employed to create a refractive optic. Known in the art, modal lenses incorporate a single, continuous low conductivity circular electrode surrounded by, and in electrical contact with, a single high conductivity ring-shaped electrode. Upon application of a single voltage to the high conductivity ring electrode, the low conductivity electrode, essentially a radially symmetric, electrically resistive network, produces a voltage gradient across the layer of liquid crystal, which subsequently induces a refractive index gradient in the liquid crystal. A layer of liquid crystal with a refractive index gradient will function as an electro-active lens and will focus light incident upon it.

In some embodiments, a dynamic optic is used in combination with a Progressive Addition Lens to form a combined lens. The Progressive Addition Lens can be a low add power Progressive Addition Lens. The Progressive Addition Lens comprises a progressive addition region. The dynamic optic can be located such that it is in optical communication with the progressive addition region. The dynamic optic is spaced apart from the progressive addition region, but is in optical communication therewith.

In some embodiments, the progressive addition region can have an add powers of one of: +0.50D, +0.75D, +1.00D, +1.12D, +1.2.5D, +1.37D, and +1.50D. In some embodiments, the dynamic optic can have an optical power of one of: +0.50D, +0.75D, +1.001), +1.12D, +1.25D, +1.37D, +1.50D, +1 62D, +1.75D, +2.00D, and +2.25D in an activated state. The add power of the progressive addition region and the optical power of the dynamic optic can be manufactured or prescribed to a patient in either +0.125D (which is rounded to either +0.12D or +0.13D) steps or in +0.25D steps.

It should be pointed out that the invention contemplates any and all possible power combinations, both static and dynamic, needed to correct the wearer's vision properly at far, intermediate and near viewing distances the inventive examples and embodiments provided within this disclosure are merely illustrative and are not intended to be limiting in any way. Rather they are intended to show additive optical power relationships when a low add power progressive addition region is in optical communication with a dynamic optic.

The dynamic optic can have a blend zone such that the optical power along the element's peripheral edge is blended so as to reduce the visibility of the peripheral edge when the element is activated. In most, but not all cases, the dynamic optic's optical power can transition in the blend zone from a maximum optical power contributed by the dynamic optic when activated to an optical power found in the Progressive Addition Lens. In some embodiments, the blend zone can be 1 mm-4 mm in width along the peripheral edge of the dynamic optic. In other embodiments, the blend zone can be 1 mm-2 mm in width along the peripheral edge of the dynamic optic.

When the dynamic optic is deactivated, the dynamic optic will provide substantially no optical add power. Thus, when the dynamic optic is deactivated, the Progressive Addition Lens can provide all of the add power for the combined lens (i.e., the total add power, of the combined optic is equal to the add power of the PAL). If a dynamic optic includes a blend zone, in the deactivated state the blend zone contributes substantially no optical power and substantially no unwanted astigmatism due to refractive index matching in the deactivated state. In some embodiments, when the dynamic optic is deactivated, the total unwanted astigmatism within the combined lens is substantially equal to that contributed by the Progressive Addition Lens. In an embodiment of the invention, when the dynamic optic is deactivated, the total add power of the combined optic can be approximately +1.00D and the total unwanted astigmatism within the combined lens can be approximately 1.00D or less. In other embodiments, when the dynamic optic is deactivated, the total add power of the combined optic can be approximately +1.25D and the total unwanted astigmatism within the combined lens can be approximately 1.25D or less. In still other embodiments, when the dynamic optic is deactivated, the total add power of the combined optic can be approximately +1.50D and the total unwanted astigmatism within the combined lens can be approximately 1.50D or less.

When the dynamic optic is activated, the dynamic optic will provide additional optical power. Since the dynamic optic is in optical communication with the Progressive Addition Lens, the total add power of the combined optic is equal to the add power of the PAL and the additive optical power of the dynamic optic. If a dynamic optic includes a blend zone, in the activated state the blend zone contributes optical power and unwanted astigmatism due to refractive index mismatching in the activated state and is largely not usable for vision focus. Thus, when the dynamic optic includes a blend zone, the unwanted astigmatism of the combined optic is measured only within the usable portion of the dynamic optic which does not include the blend zone. In some embodiments, when the dynamic optic is activated, the total unwanted astigmatism within the combined lens as measured through the usable portion of the lens can be substantially equal to the unwanted astigmatism within the Progressive Addition Lens. In some embodiments, when the dynamic optic is activated and the total add power of the combined optic is between approximately +0.75D and approximately +2.25D, the total unwanted astigmatism within the usable portion of the combined lens can be 1.00D or less. In other embodiments, when the dynamic optic is activated and the total add power of the combined optic is between approximately +2.50D and approximately +2.75D, the total unwanted astigmatism within the usable portion of the combined lens can be 1.25D or less. In still other embodiments, when the dynamic optic is activated and the total add power of the combined optic is between approximately +3.00D and approximately +3.50D, the total unwanted astigmatism within the usable portion of the combined lens can be 1.50D or less. Thus, the invention allows for the creation of a lens with a total add power significantly higher than the lens's unwanted astigmatism as measured through the usable portion of the lens. Or said another way, for a given total add power of the inventive combined lens, the degree of unwanted astigmatism is reduced substantially. This is a significant degree of improvement as to what is taught in the literature or what is commercially available. This improvement translates into a higher adaptation rate, less distortion, less tripping or disorientation of the wearer and a much wider clear field of view for intermediate and near distance viewing by the wearer.

In some embodiments the dynamic optic can contribute between approximately 30% and approximately 70% of the total add power required for a user's new distance vision prescription. The progressive addition region of the low add power PAL can contribute the remainder of the add power required for a user's near distance vision prescription, namely, between approximately 70% and approximately 30%, respectively. In other embodiments, the dynamic optic and the progressive addition region can each contribute approximately 50% of the total add power required for a user's near distance vision prescription. If the dynamic optic contributes too much of the total add power, when the dynamic lens is deactivated the user may not be able to see clearly at an intermediate distance. Additionally, when the dynamic optic is activated, the user may have too much optical power in the intermediate distance viewing zone and as such may not be able to see clearly at an intermediate distance. If the dynamic optic contributes too little of the total add power, the combined lens can have too much unwanted astigmatism.

When the dynamic optic includes a blend zone, it can be necessary for the dynamic optic to be wide enough to ensure that at least a portion of the blend zone is located in the periphery of the combined optic. In some embodiments, the horizontal width of the dynamic optic can be approximately 26 mm or greater. In other embodiments, the horizontal width of the dynamic optic can be between approximately 24 mm and approximately 40 mm. In still other embodiments, the horizontal width of the dynamic optic is between approximately 30 mm and approximately 34 mm. If the dynamic optic is less than approximately 24 mm in width, it is possible that the blend zone can interfere with a user's vision and create too much distortion and swim for the user when the dynamic optic is activated. If the dynamic optic is greater than approximately 40 mm in width, it can be difficult to edge the combined lens into the shape of an eyeglass frame. In most, but not all cases, when the dynamic optic is located with its blend zone at or below the fitting point of the combined lens, the dynamic optic can have an oval shape with a horizontal width dimension larger than its vertical height dimension. When the dynamic optic is located with its blend zone above the fitting point the dynamic optic is usually, but not always, located such that a top peripheral edge of the dynamic optic is a minimum of 8 mm above the fitting point. It should be noted that dynamic optics that are not electro-active can be placed to the peripheral edge of the combined lens. Additionally, such non-electro-active dynamic optics can be less than 24 mm wide.

In some embodiments, the dynamic optic is located at or above the fitting point. A top peripheral edge of the dynamic optic can be between approximately 0 mm and 15 mm above the fitting point. The dynamic optic is able to provide, when activated, the needed optical power when the wearer is looking at an intermediate distance, a near distance or somewhere between the intermediate and near distance (near-intermediate distance). This results from the dynamic optic being located at or above the fitting point. This will allow the user to have a correct intermediate distance prescription when looking straight ahead. Additionally, because of the progressive addition region, the optical power continuously increases from the fitting point downward through the channel. The user will have a correct near-intermediate distance and near distance prescription correction when looking through the channel. Thus, the user may, in many circumstances, not need to look downward as far or have to raise their chin as far to see through the intermediate distance viewing zone of the lens. If the dynamic optic is spaced vertically from the top of the combined lens, the user may also be able to see at a far distance by utilizing a portion of the combined lens above the activated dynamic optic. When the dynamic optic is deactivated, the area of the lens at or near the fitting point will return to the far distance optical power of the lens.

In embodiments in which the dynamic optic has a blend zone, it can be preferable to locate the dynamic optic above the fitting point. In such embodiments, when the dynamic optic is activated, a user can look straight ahead through the fitting point and downward through the channel without looking through the blend zone. As mentioned above, the blend zone can introduce a high degree of unwanted astigmatism which can be uncomfortable to look through. Thus, the user can make use of the combined optic in the activated state without experiencing a high degree of unwanted astigmatism as the user will not have to pass over the edge or blend zone of the dynamic optic.

In some embodiments, the dynamic optic is located below the fitting point. A top peripheral edge of the dynamic optic can be between approximately 0 mm and 15 mm below the fitting point. When the user looks straight ahead through the fitting point, a far distance prescription correction is provided by the combined optic as the dynamic optic is not in optical communication with this portion of the combined lens. However, when the user shifts his or her gaze from the fitting point downward through the channel, the user can experience a high degree of unwanted astigmatism as the user's eyes pass over the blend zone of the dynamic optic. This can be rectified in a variety of ways which are detailed below.

The inventive combined ophthalmic lens comprises an optical design that takes into consideration: 1) the total near distance add power required of the inventive ophthalmic lens to satisfy the near vision correction of a wearer; 2) The level of unwanted astigmatism or distortion in the usable portion of the combined lens; 3) The amount of optical add power contributed in part by the progressive addition region; 4) The amount of optical power contributed by the dynamic optic when activated; 5) The channel length of the progressive addition region; 6) The design of the progressive addition region in terms of whether it is, by way of example only, a soft PAL design, a hard PAL design, a modified soft PAL design or a modified hard PAL design; 7) The width and height of the dynamic optic; and 8) The location of the dynamic optic with respect to the progressive addition region.

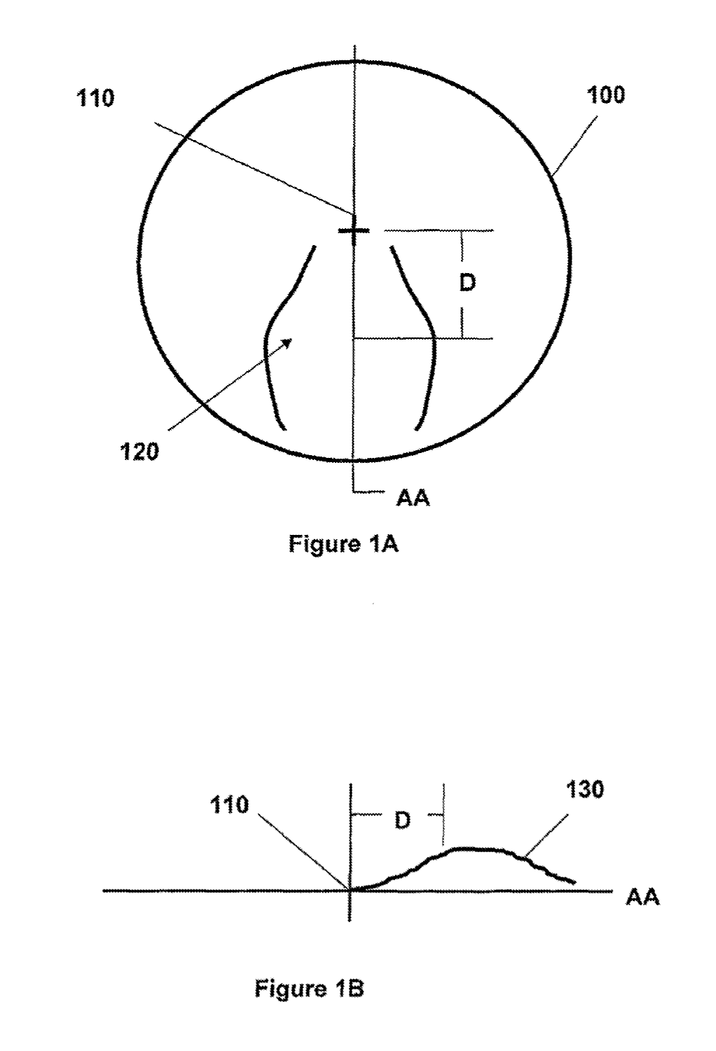

FIG. 1A shows an embodiment of a Progressive Addition Lens 100 having a fitting point 110 and a progressive addition region 120. The Progressive Addition Lens in FIG. 1A is a low add power Progressive Addition Lens designed to provide a wearer with a desired optical power less than the wearer's needed near distance optical power correction. For example, the add power of the PAL can be 50% of the near distance optical power correction. The distance along axis line AA of the lens from the fitting point to the point on the lens where the optical power is within 85% of the desired add optical power is known as the channel length. The channel length is designated in FIG. 1A as distance D. The value of distance D can be varied depending upon many factors, such as the style of frame the lens will be edged to fit, how much optical power is required, and how wide a channel width is required. In an embodiment of the invention, the distance D is between approximately 11 mm and approximately 20 mm. In another embodiment of the invention the distance D is between approximately 14 mm and approximately 18 mm.

FIG. 1B shows a graph of optical power 130 taken along a cross section of the lens of FIG. 1A, along axis line AA. The x-axis of the graph represents distance along axis line AA in the lens. The y-axis of the graph represents the amount of optical power within the lens. The optical power shown in the graph begins at the fitting point. The optical power before or at the fitting point can be approximately +0.00D to approximately +0.12D (i.e., approximately no optical power) or can have a positive or negative dioptric power depending on the far distance prescriptive needs of a user. FIG. 1B shows the lens as having no optical power before or at the fitting point. After the fitting point, the optical power continuously increases to a maximum power. The maximum power can persist for some length of the lens along axis line AA. FIG. 1B shows the maximum power persisting, which appears as a plateau of optical power. FIG. 1B also shows that the distance D occurs before the maximum power. After the maximum power plateau, the optical power can then continuously decrease until a desired optical power. The desired optical power can be any power less than the maximum power and can be equal to the optical power at the fitting point. FIG. 1B shows the optical power continuously decreasing after the maximum power.

In some embodiments, the progressive addition region can be a progressive addition surface located on the front surface of the lens and the dynamic optic can be buried inside the lens. In other embodiments, the progressive addition region can be a progressive addition surface located on the back surface of the lens and the dynamic optic can be buried inside the lens. In other embodiments, the progressive addition region can be two progressive addition surfaces with one surface located on the front surface of the lens and the second surface located on the back surface of the lens (as that of a dual surface Progressive Addition Lens) and the dynamic optic can be buried inside the lens. In still other inventive embodiments, the progressive addition region cannot be produced by a geometric surface, but instead can be produced by a refractive index gradient. Such an embodiment would allow both surfaces of the lens to be similar to surfaces used on single focus lenses. Such a refractive index gradient providing a progressive addition region can be located inside the lens or on a surface of the lens.

As described above, even when the dynamic optic is in a deactivated state, the wearer will always have the correct intermediate distance and far distance vision optical power. Therefore, the only control mechanism that may be required is a means for selectively activating the dynamic optic when a proper near distance optical power is needed for the wearer. This effect is provided by the low add power PAL having an add power that provides less optical power at a near distance than a user's prescriptive near distance needs, and further that this lower add power approximates the correct prescriptive optical power for the wearer's intermediate distance viewing needs. When the dynamic optic is activated, the wearer's near distance optical power focusing needs will be satisfied.

This can greatly simplify the sensor suite required to control the lens. In fact, all that may be required is a sensing device that can detect if a user is focusing beyond an intermediate distance. If the user is focusing closer than a far distance, the dynamic optic can be activated. If the user is not focusing closet than a far distance, the dynamic optic can be deactivated. Such a device can be a simple tilt switch, a manual switch, or a range finder.

Because the dynamic optical element provides correct intermediate distance and far distance optical power in the deactivated state, the dynamic optic is considered fail-safe. In other words, if the dynamic optical element fails, then the wearer will still have intermediate distance viewing and far distance viewing. For example, if the user is driving and the dynamic optical element stops working so that the dynamic optical element returns to, or remains in, the deactivated state, the user will still have the intermediate distance viewing and far distance viewing needed to continue driving. In some embodiments, the dynamic optical element is an electro-active element. In such embodiments, as discussed above, the electro-active optic can have substantially the same refractive index as the diffractive relief surface structure in the deactivated state.

In some embodiments, a small amount of temporal delay can be placed in the control system so that the patient's eye passes past the point of the peripheral edge of the dynamic optic before the dynamic optic is activated. This allows the wearer to avoid any unpleasant unwanted distortion effects that might be caused by looking through the peripheral edge of the dynamic optic. Such an embodiment can be beneficial when the dynamic optic includes a blend zone. By way of example only, when a line of sight of the wearer is to move from viewing a far distance object to a near distance object, the wearer's eye will translate over the peripheral edge of the dynamic optic into the near distance viewing zone. In such a case, the dynamic optic will not be activated until the wearer's line of sight has already transitioned past the peripheral edge of the dynamic optic and into the near distance viewing zone. This occurs by delaying the time to activate the dynamic optic in order to allow the line of sight of the wearer to pass over the peripheral edge. If the activation of the dynamic optic was not temporally delayed and was instead activated before the wearer's line of sight transitioned over the peripheral edge, the wearer might experience a high degree of unwanted astigmatism while looking through the peripheral edge. Such embodiments can be utilized mostly when the dynamic optic's peripheral edge is located at or below the fitting point of the combined lens. In other embodiments the dynamic optic's peripheral edge can be located above the fitting point of the combined lens and thus, in most cases, the delay may not be needed as the line of sight of the wearer never passes over the peripheral edge of the dynamic optic when looking between an intermediate distance and a near distance.

In still other embodiments, the Progressive Addition Lens and the blend zone of the dynamic optic can be designed such that in the area where the two overlap the unwanted astigmatism in the blend zone at least partially cancels out some of the unwanted astigmatism in, the PAL. This effect is comparable to a dual-sided PAL in which one surface's unwanted astigmatism is designed to cancel out some of the other, surface's unwanted astigmatism.

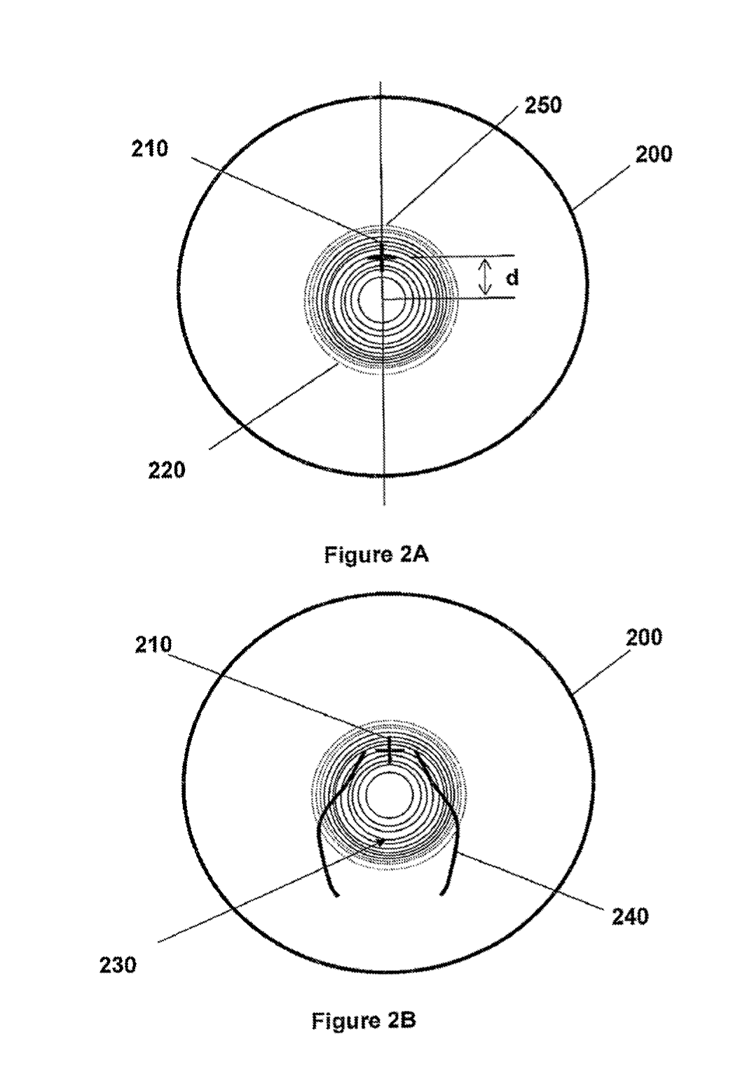

In some embodiments, it can be desirable to increase the size of a dynamic optic and locate the dynamic optic so that a top peripheral edge of the dynamic optic is above a fitting point of the lens. FIG. 2A shows an embodiment of a low add power Progressive Addition Lens 200 combined with a much larger dynamic optic 220 placed such that a top peripheral edge 250 of the dynamic optic lies above the fitting point 210 of the lens. In an embodiment of the invention, the diameter of the larger dynamic optic is between approximately 24 mm and approximately 40 mm. The vertical displacement of the dynamic optic relative to the fitting point of the lens is designated by the distance d. In some embodiments, distance d is in a range of approximately 0 mm to a distance equal to approximately one half the diameter of the dynamic optic. In other embodiments, the distance d is a distance between approximately one eighth the diameter of the dynamic optic and three eighths the diameter of the dynamic optic. FIG. 2B shows an embodiment having a combined optical power 230 that is created because the dynamic optic is in optical communication with a progressive addition region 240. The lens 200 can have a reduced channel length. In some embodiments, the channel length is between approximately 11 mm and approximately 20 mm. In other embodiments, the channel length is between approximately 14 mm and approximately 18 mm.

In the embodiments illustrated in FIGS. 2A and 2B, when the dynamic optic is activated, because the lens is a low add power PAL and the dynamic optic is located above the fitting point, the wearer has correct intermediate distance vision while looking straight ahead. The wearer also has correct near-intermediate distance as the wearer's eye moves down the channel. Finally, the wearer has correct near distance vision within the area of the combined lens where the power of the dynamic optic and the progressive addition region combine to form the required near viewing distance correction. This is an advantageous method of combining the dynamic optic with the progressive addition region, since computer use is largely an intermediate viewing distance task and is one in which many people view the computer screen in a straight ahead or very slightly downward viewing posture. In the deactivated state, the area of the lens above and neat the fitting point allows for distance vision viewing correction with a weak progressive power below the fitting point. The maximum optical power of the progressive addition region contributes approximately one half the required neat distance optical power for a wearer and the dynamic optic contributes the remainder, of the optical power needed for clear near distance vision.

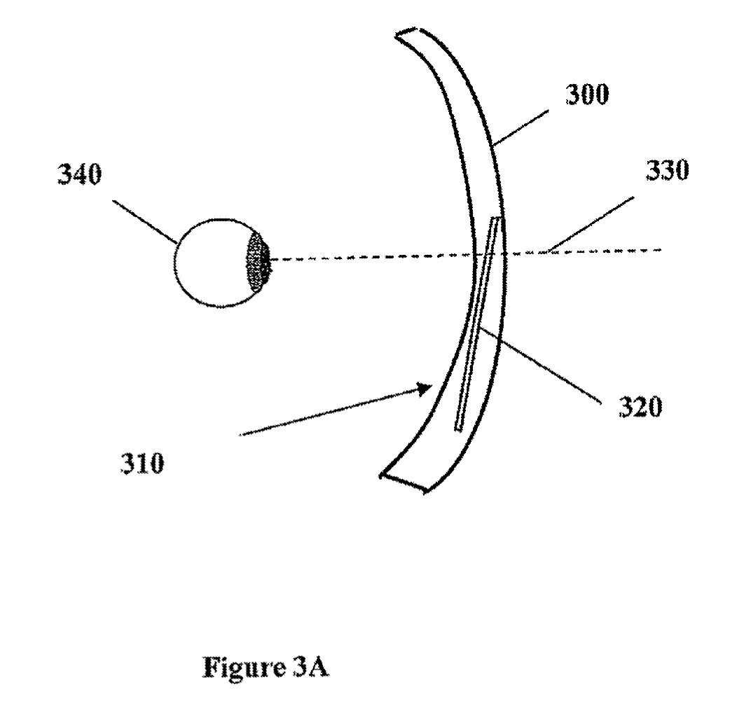

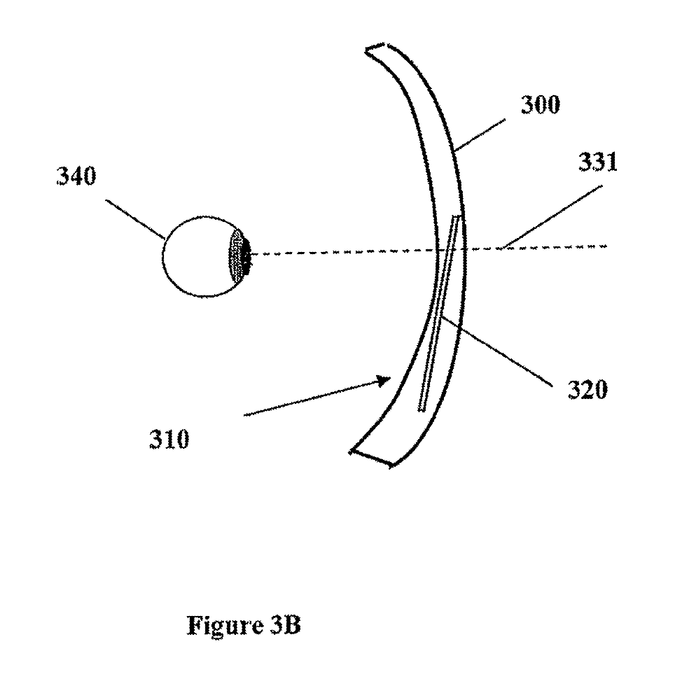

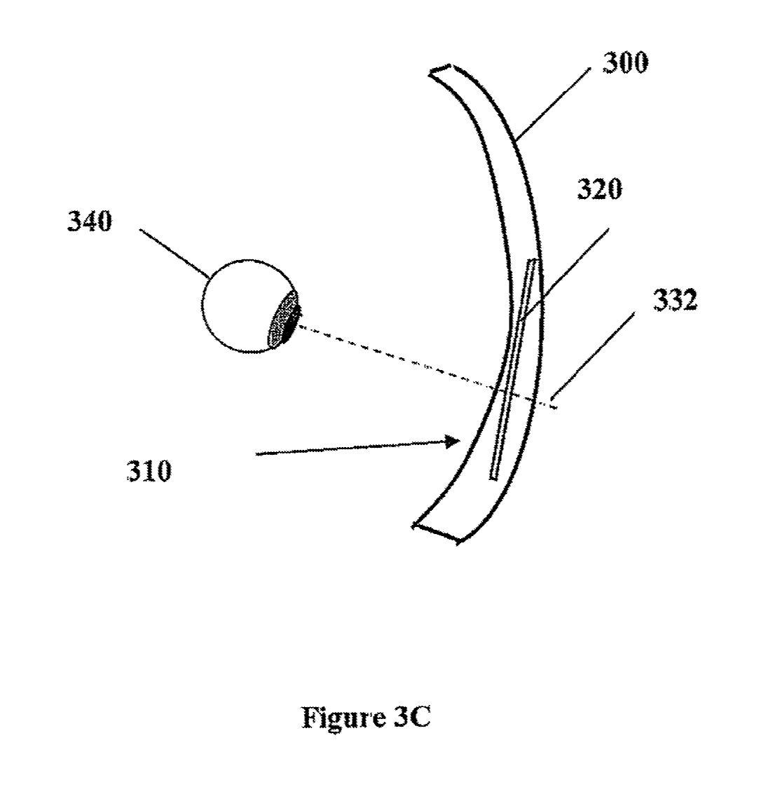

FIGS. 3A-3C illustrate an embodiment of the invention, in which the dynamic optic 320 is placed within the lens 300, and the progressive addition region 310 is placed on the back surface of the lens. This back progressive addition surface can be placed on the lens during the processing of a semi-finished lens blank having an integrated dynamic optic by means of a fabrication approach known as free forming. In other embodiments, the progressive addition region is located on the front surface of the semi-finished lens blank. The semi-finished lens blank incorporates the dynamic optic such that the dynamic optic is in proper alignment with the progressive addition surface curvature. The semi-finished lens blank is then processed by conventional surfacing, polishing, edging, and mounting into an eyeglass frame.

As illustrated in FIG. 3A, when the dynamic optic is deactivated, the optical power taken along a line of sight from a wearer's eye 340 through the fitting point provides the wearer with correct far distance vision 330. As illustrated in FIG. 3B, when the dynamic optic is activated, the optical power taken along a line of sight from the wearer's eye through the fitting point provides the wearer with a correct intermediate distance focusing power 331. As the wearer moves his or her gaze down the channel as shown in FIGS. 3B-3C, the combined optics of the dynamic optic and the progressive addition surface provides a mostly continuous power transition from intermediate distance focus to neat distance focus. Thus, as illustrated in FIG. 3C, when the dynamic optic is activated, the optical power taken along a line of sight from the wearer's eye through the near distance viewing zone provides the wearer with a correct near distance focusing power 332. In such embodiments, the control system only needs to decide if the wearer is looking to a far distance. In such a case of distance viewing the dynamic optic can remain in the deactivated state. In embodiments where a range finding device is used, the ranging system only needs to decide if an object is closer to the eye than one's intermediate distance. In such a case the dynamic optic would be activated to provide a combined optical power allowing for simultaneous intermediate distance and near distance optical power correction. In such embodiments, the eye does not have to pass over or cross the upper edge of the dynamic optic when it is turned on such as when a user looks from a far distance portion of the lens to a near distance portion of the lens and vice versa. If the dynamic optic has its upper most edge located below the fitting point the eye must pass over or cross this upper edge when looking from far distance to near distance or from near distance to far distance. However, some embodiments can allow the positioning of the dynamic optic below the fitting point such that the eye sloes not pass over the upper most edge of the dynamic optic. Such embodiments can allow for other advantages with regard to visual performance and ergonomics.

While FIGS. 3A-3C illustrate the progressive addition surface region on the back surface, it can also be placed on the front surface of the lens or located on both the front and back surfaces of the lens while the dynamic optic can be located within the lens. Additionally, while the dynamic optic is illustrated as located inside the lens, it can also be placed on the surface of the lens if it were made from curved substrates and covered by an ophthalmic covering material. By using one dynamic optic having a known optical power in combination with different PAL lenses each having a different add power, it can be possible to reduce the number of dynamic optic semi-finished blank SKU's substantially. For example a +0.75D dynamic optic could be combined with a +0.50D, +0.75D or +1.00D progressive addition region or surface, to produce add powers of +1.25D, +1.50D or +1.75D respectively. Or a +1.00D dynamic optic could be combined with a +0.75D or +1.00D, progressive addition region or surface, to produce add powers of +1.75 or +2.00D. Moreover the progressive addition region can be optimized to account for characteristics of the wearer, such as the patient's far distance power, and eye path through the lens, as well as the fact that the progressive addition region is being added to an dynamic electro-active optic that is providing approximately half the required reading correction. Likewise the reverse also works well. For example, a +1.00D progressive addition region or surface can be combined with a +0.75D, +1.00D, +1.25D or +1.50D dynamic optic to produce a combined add power of +1.75D, +2.00D, +2.25D or +2.50D.

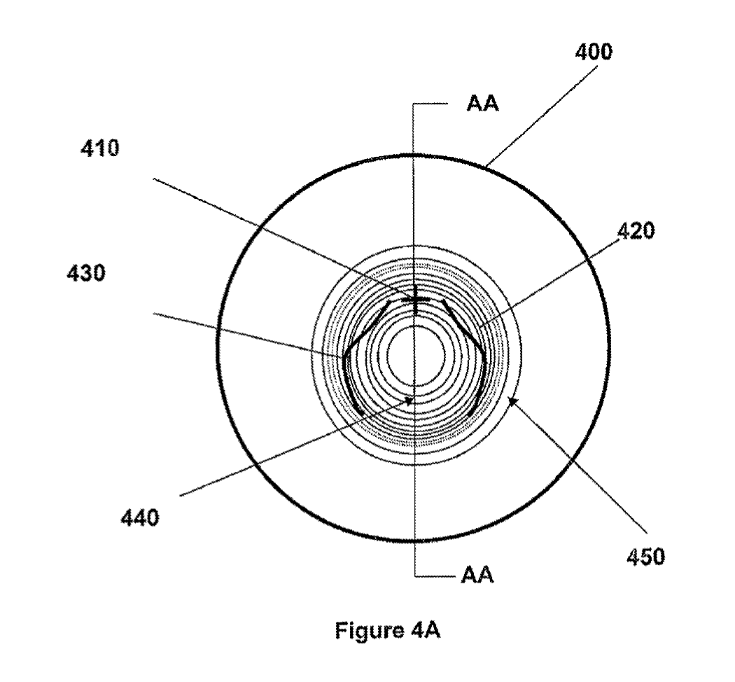

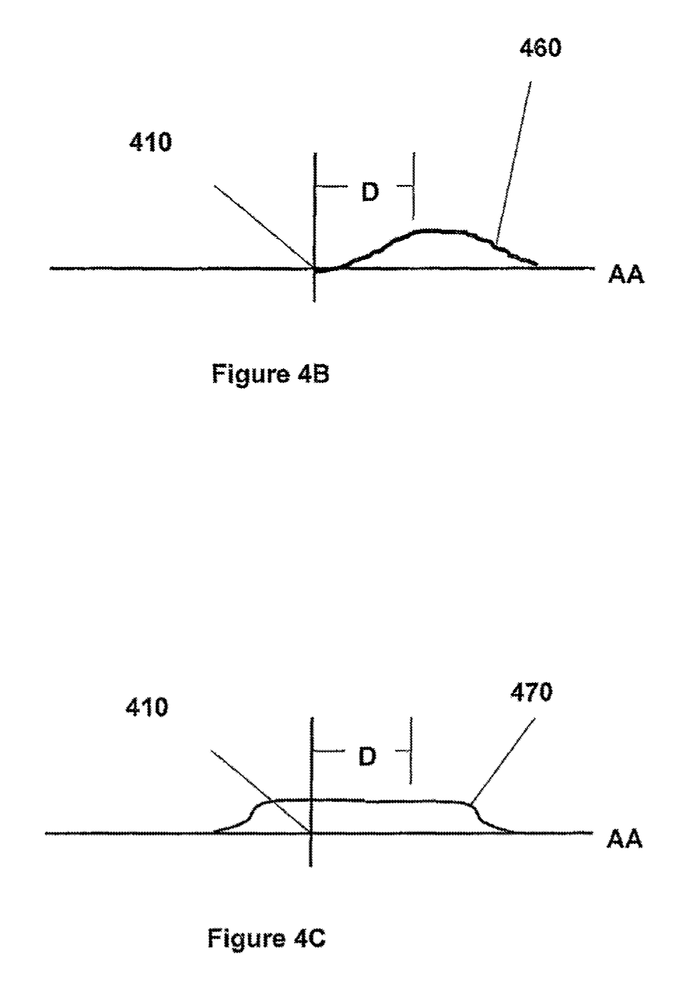

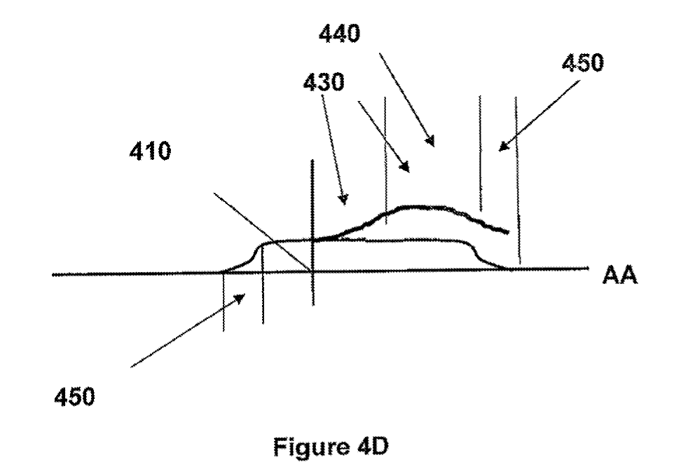

FIG. 4A illustrates another embodiment whereby a low add power Progressive Addition Lens 400 is combined with a dynamic optic 420 that is larger than the progressive addition region and/or channel 430. In this embodiment, the unwanted distortion 450 from the blend zone of the dynamic optic is well outside both the fitting point 410 and the progressive addition channel 430 and reading zones 440. FIGS. 4B-4D show graphs of optical power taken along a cross section of the lens of FIG. 4A, along axis line AA. The x-axis of each graph represents distance along axis line AA in the lens. The y-axis of each graph represents the amount of optical power within the lens. The optical power before or at the fitting point can be approximately +0.001) to approximately +0.12D (i.e., approximately no optical power) or can have a positive or negative dioptric power depending on the far distance prescriptive needs of a user. FIG. 4B shows the lens as having no optical power before or at the fitting point. FIG. 4B shows the optical power 460 that is provided by the fixed progressive addition surface or region taken along axis line AA of FIG. 4A. FIG. 4C shows the optical power 470 that is provided by the dynamic optic when activated taken along axis line AA of FIG. 4A. Finally, FIG. 4D shows the combined powers of the dynamic electro-active optic and the fixed progressive addition region taken along axis line AA of FIG. 4A. From the figure it is clear that the top and bottom distorted blend area 450 of the dynamic electro-active optic are outside both the fitting point 410 and the progressive addition reading area 440 and channel 430.

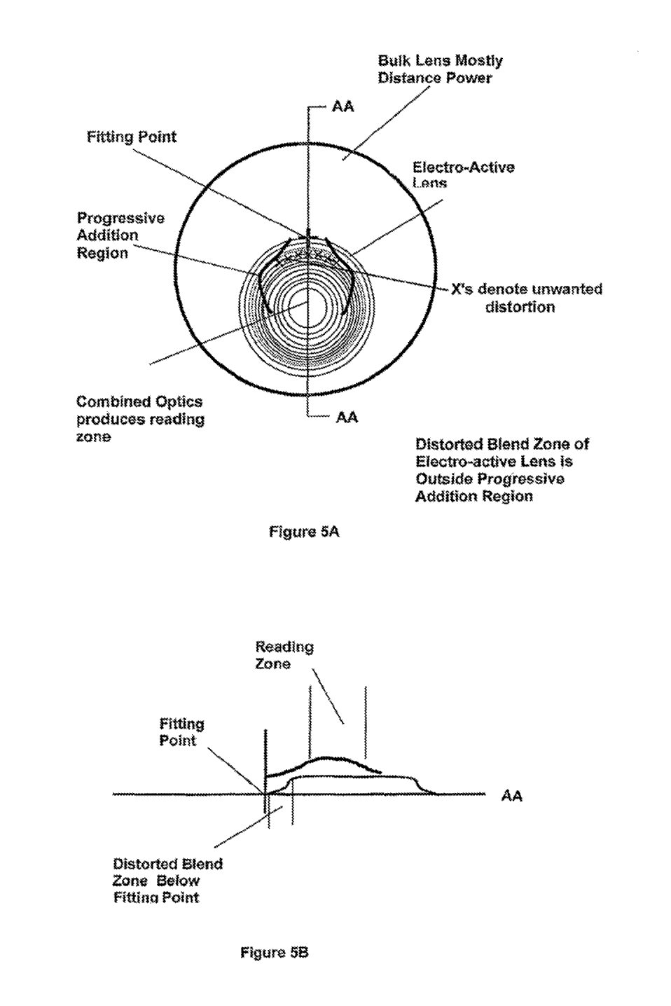

FIGS. 5A and 5B are illustrative of embodiments in which a dynamic optic 520 is located below a fitting point 510 of a low add power Progressive Addition Lens 500. In FIG. 5A, the location of the blend zone of the dynamic electro-active optic results in significant overall distortion 550 as the wearer's eye tracks down the progressive corridor 530. In certain inventive embodiments of the invention this is solved by delaying the activation of the dynamic optic until the wearer's eye has passed over the upper edge of the blend zone of the dynamic optic. FIG. 5B shows optical power along axis line AA of FIG. 5A. The region of distortion 550 is seen to overlap with the add power of the lens just below the fitting point and further shows the need to delay the activation of the dynamic optic until the eye passes over this area. Once the eye passes over this area and enters, for example, the reading zone 540 there is no longer significant optical distortion. In some embodiments, a very narrow blend zone of 1 mm-2 mm can be provided to allow for the eye to quickly pass over this area. In an embodiment of the invention, a horizontal width of the dynamic optic can be between approximately 24 mm and approximately 40 mm. In other embodiments, a horizontal width of the dynamic optic can be between approximately 30 mm and approximately 34 mm. In still other embodiments, a horizontal width of the dynamic optic can be approximately 32 mm. Thus, in certain embodiments the dynamic optic is shaped more like an oval with the horizontal measurement being wider than the vertical measurement.

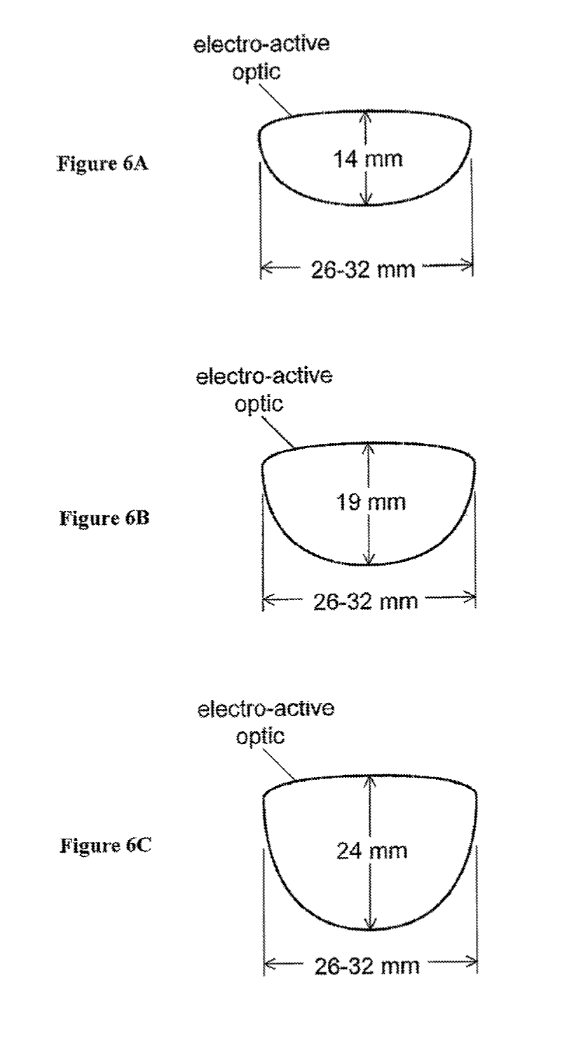

FIGS. 6A-6C show embodiments of a dynamic optic. In the embodiments shown, the dynamic optic has an oval shape and is between approximately 26 mm and approximately 32 mm wide. Various heights of the dynamic optic are shown. FIG. 6A shows a dynamic optic with a height of approximately 14 mm. FIG. 6B shows a dynamic optic with a height of approximately 19 mm. FIG. 6C shows a dynamic optic with a height of approximately 24 mm.

It is further contemplated within the invention that the dynamic optic can need to be off center vertically and in some cases horizontally relative to the progressive addition region depending upon the wearer's pupillary distance, fitting point, and dimensions of the frame eye-wire cut out. However, in all cases when the dynamic optic is off-center relative to the progressive addition region it remains in optical communication with the region when the dynamic optic is activated. It should be noted that the vertical dimension of the frame's eye-wire or rim will in many, but not all cases, determine this amount of off-centeredness.

The inventive ophthalmic lens allows for an optical transmission of 88% or more. If an antireflection coating is utilized on both surfaces of the ophthalmic lens the optical transmission will be in excess of 90%. The optical efficiency of the inventive ophthalmic lens is 90% or better. The inventive ophthalmic lens is capable of being coated with a variety of well-known lens treatments such as, by way of example only, an antireflection coating, a scratch resistant coating, a cushion coating, a hydrophobic coating, and an ultra-violet coating, The ultra-violet coating can be applied to the ophthalmic lens or to the dynamic optic. In embodiments in which the dynamic optic is a liquid-crystal based electro-active optic, the ultra-violet coating can protect the liquid crystal from ultra-violet light that could damage the liquid crystal over, time. The inventive ophthalmic lens is also capable of being edged into the shape needed for an eyeglass flame, or drilled in its periphery so as to be mounted, by way of example only, in a rimless frame.

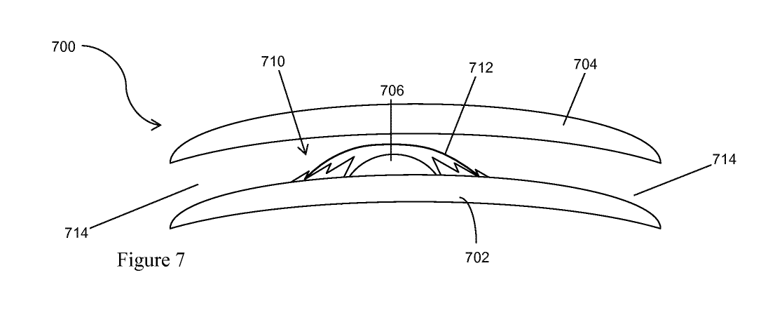

As discussed above, in some embodiments the device includes a lens having an electro-active element containing a liquid crystalline material. FIG. 7 is an exemplary cross-sectional view of such an electro-active element. Electro-active element 700 can include a first or rear substrate 702 and a second or front substrate 704. First substrate 702 can have a diffractive surface relief structure 706, which can be formed according to any of the methods discussed above. In some embodiments, a framing layer (not shown) can at least partially surround diffractive surface relief structure 706. In some embodiments, the framing layer can be constructed of the same material as first substrate 702 and/or second substrate 704. In some embodiments, the framing layer can be an extension of first substrate 702 in which no actual layer is added, however, first substrate 702 can be fabricated so as to frame or circumscribe diffractive surface relief structure 706. In some embodiments, there is no framing layer. Electro-active element 700 can also include a cavity 710 having a shape defined by at least diffractive surface relief structure 706 of first substrate 702 and second substrate 704. A liquid crystalline mixture 712 can be disposed in cavity 710. The combination of diffractive surface relief structure 706 and liquid crystalline mixture 712 can act as a near distance zone. An adhesive 714 can be used to adhere first substrate 702 and second substrate 704 together. Adhesive 714 can be chosen that has an index of refraction matching first substrate 702 and/or second substrate 704.

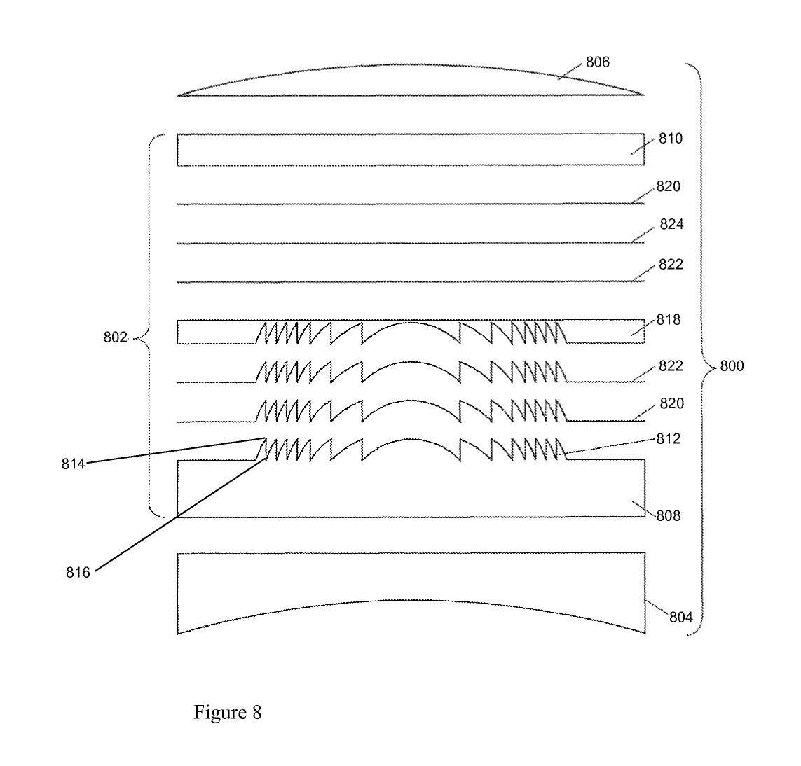

FIG. 8 illustrates an exploded cross-sectional view of an exemplary electro-active lens 800. Electro-active lens 800 can have an electro-active element 802 which is adhesively attached to a first optical element 804 and a second optical element 806. Either or both optical elements can have external surfaces which can be unfinished, semi-finished, or finished. The optical design of one or both of the optical surfaces can be optimized to allow certain features of the optical design (e.g., a progressive addition region having an add power) to be in optical communication with electro-active element 802. Electro-active element 802 is merely exemplary. Electro-active element 802 is similar to electro-active element 700, but has additional components as discussed below. Electro-active element 802 can have a first or rear substrate 808 and a second or front substrate 810. Alternatively, one or both of optical elements 804 and 806 can be used as a substrate. First substrate 810 can have a diffractive optical power region having diffractive surface relief structures 812. As can be seen in FIG. 8, diffractive surface relief structure 812 can have a depth equal to the distance from the structure's crest 814 to the structure's trough 816. Surface relief diffractive structures 812 can be continuous circles or ellipses. In some embodiments, second substrate 810 can be substantially flat. Alternatively, second substrate 810 can also have a diffractive surface relief structure. As another alternative, first substrate 808 can be substantially flat and second substrate 810 can have a surface relief diffractive structure. Liquid crystalline material 818 can be constrained by first substrate 808 and second substrate 810. The liquid crystalline material can be a nematic liquid crystal, a cholesteric liquid crystal, a smectic liquid crystal, a polymer dispersed liquid crystal, or a polymer stabilized liquid crystal. Both first substrate 808 and second substrate 810 can be coated with a transparent electrode 820 for applying an electric field to liquid crystalline material 818. An alignment layer 822 can be disposed on top of electrode 820. The electrodes can have electrical contacts (not shown) to allow electrical connection to a controller. The alignment layers can preferentially align the layer of liquid crystal in a predetermined alignment direction relative to the substrates. To avoid electrical conduction (i.e., electrical shorting) between the two transparent electrodes, one or more electrical insulating layers 824 can be disposed between electrodes 820. A more detailed description of the various components of the electro-active lens can be found in U.S. Pat. No. 8,319,937, which is incorporated herein by reference in its entirety. It should be understood that the electro-active element can be curved in some embodiments of the invention. A more detailed description of such embodiments can be found in U.S. Pat. No. 7,728,949, which is incorporated herein by reference in its entirety.

The choice for the liquid crystalline material can impact the operation of the electro-active element. For example, visco-elastic properties of liquid crystalline material, as well as their electrical and optical properties, define the static and dynamic characteristics of liquid crystalline-based devices, such as, for example, an electro-active lens. Flow viscosity, and especially the rotational viscosity, is an important physical property of liquid crystalline material that determines the response time of the liquid crystalline-based device. In some embodiments, electro-optical devices use liquid crystalline material in the nematic phase. In such embodiments, the response time is proportional to the rotational viscosity, γ₁. The rotational viscosity, γ₁ characterizes the friction between the liquid crystalline molecules during molecular rotations. In other words, rotational viscosity can determine the rate of reorientation of liquid crystalline material direction as a response to the change of an externally applied field, for example, an electric or magnetic field.

Equations (1)-(3) below present the basic relationships between the switching voltage (V_{c}) and response times (τₒₙ and τ_{off}) and molecular parameters of nematic liquid crystalline materials in an electro-active device:

V_{c}=π{Kᵢᵢ/(∈₀Δ∈)}^{1/2} (1)

Tₒₙ=γ₁d²/(∈₀Δ∈V²−κπ²) (2)

T_{off}=γ₁d²/(κπ²) (3)

wherein: Kᵢᵢ is the elastic constant of the liquid crystalline material,
∈₀ is the dielectric permittivity,
Δ∈ is the dielectric anisotropy,
γ₁ is the rotational viscosity, and
d is the liquid crystalline cell thickness.

The above equations show that liquid crystalline materials with lower rotational viscosity will result in devices with a faster response to the changes in the applied field, while having higher dielectric anisotropy will yield liquid crystalline-devices that require lower switching voltage and have fast response.

The magnitude of rotational viscosity γ₁ depends on temperature, intermolecular interactions and molecular structure. The relationship between structure and rotational viscosity is particularly interesting because by modifying the liquid crystalline structure, one could tailor the molecules in order to reduce the viscosity. Several theories have been developed in an attempt to account for the origin of liquid crystalline material viscosity. However, due to the complicated anisotropic attractive and steric repulsive interactions among liquid crystalline molecules, these theories are not yet completely satisfactory. The effects, such as structural rigidity of molecules and strong polar intermolecular interactions do affect the flow and rotational viscosity, but their contribution is hard to predict. Therefore, some of the proposed models for viscosity fit certain categories of liquid crystalline material, but fail to fit others.

Also, while the flow viscosity of liquid crystalline materials are readily available, the rotational viscosity is not widely available due to the more complicated methods for its measurement. There are only a few empirical correlations between the flow viscosity and rotational viscosity for given classes of liquid crystalline materials. In general, liquid crystalline mixtures that have high flow viscosity show high rotational viscosity, as well. However, this rule is not always the case, because both viscosities (flow viscosity and rotational viscosity) are independent physical properties.

Taking into account the above mentioned challenges with liquid crystalline material viscosity and structure, it is hard to pre-determine a desired set of liquid crystalline material properties for a given use. There are numerous commercially-available liquid crystalline material mixtures that are offered on the market for different electro-active applications. However, these commercially-available liquid crystalline material mixtures do not always have the right set of properties that would be satisfactory for the particular use. For example, for a preferred electro-active ophthalmic lens, the liquid crystalline material should have:
low haze value due to the aesthetic requirement the electro-active zone (i.e. reading zone) in the ophthalmic lens not to be noticeable when the lens is placed on a user's face;
low viscosity, particularly low rotational viscosity (for example, 50 mPa·s or less), which will result in a lens with a fast response time;
high dielectric anisotropy (for example, 10 or higher) that will lead to a faster responsive lens, which consumes less energy;
high birefringence (for example, 0.26 or higher) which will enable wide spectrum of prescriptions within a reasonable cell thickness;
right extraordinary and ordinary indices, as well as their right dispersion over the visible wavelength range, that will match the properties of the material used as a lens substrate; and
stable mesomorphic/nematic range and sufficiently high isotropic temperature (for example, 100° C. or higher) that will allow stable operation of the electro-active zone of the lenses even in the conditions when the lens is exposed to elevated temperatures in the summer and to lower temperatures in winter.

To find the appropriate liquid crystalline material mixtures for dynamic electro-active lenses is a challenge. Many liquid crystalline materials have satisfactory optical and dielectric properties, but are liquids with high rotational viscosity (above 50 mPa·s), which will affect the cosmetic haze and haze clearing time, i.e. the rate of clearing of cloudiness after the lens is switched off. Therefore, embodiments of the present invention are focused on identifying liquid crystalline materials with a right set of electrical, optical and visco-elastic properties for their potential application in electro-active ophthalmic lenses having specific properties without compromising the final performance of the lenses. Embodiments of the present invention are also focused on identifying liquid crystalline materials having a low rotational viscosity (50 mPa·s or less) that work in combination with the features of a diffractive surface relief structure to provide fail-safe operation of the device. In some embodiments, the device can be the electro-active lens or a pair of spectacles containing the electro-active lens.

As discussed above, the refractive index of a liquid crystalline material can be changed by generating an electric field across the liquid crystal. By applying voltage to the liquid crystal through a pair of electrodes, the optical power correction provided by a diffractive surface relief structure can be switched on and off by means of refractive index mismatching and matching, respectively. When substantially no voltage is applied (i.e., the deactivated state), the liquid crystal can have substantially the same refractive index as the diffractive surface relief structure. This cancels out the optical power that would normally be provided by the diffractive surface relief structure and provide fail-safe operation. When voltage is applied, the liquid crystal can have a different refractive index than the surface relief diffractive element such that the surface relief diffractive element now provides optical add power. Thus, the liquid crystalline material can have a first index of refraction when an electro-active element is in an activated state and a second index of refraction, different from the first index of refraction, when the electro-active element is in the deactivated state. Further in some embodiments, the second index of refraction (i.e., in the deactivated state) of the liquid crystalline material matches or is substantially the same as the index of refraction of the diffractive surface relief structure. As discussed above, two indices of refraction are considered to be substantially the same when they are within 0.03 of each other.

Properties of the diffractive surface relief structure which impact the functioning of the electro-active element include the index of refraction and the depth. In some embodiments, the material that makes up the diffractive surface relief structure can have an average index of refraction in a range from 1.5 to 2, preferably in a range from 1.5 to 1.8. As used herein, the index of refraction of a material refers to the average index of refraction, which is an average of the ordinary refractive index and the extra-ordinary refractive index for the material. To the extent the indices of refraction vary with wavelength, the indices of refraction as measured and claimed herein is at a wavelength of 589 nm. In some embodiments, the depth of the diffractive surface relief structure is in a range from 1 micron to 10 microns.

In some embodiments, the liquid crystalline material has a low rotational viscosity, for example a rotational viscosity of 50 mPa·s or less, 45 mPa·s or less, 40 mPa·s or less, 35 mPa·s or less, 30 mPa·s or less, or 25 mPa·s or less. In some embodiments, the liquid crystalline material has a rotational viscosity in a range from 25 mPa·s to 50 mPa·s.

In some embodiments, the liquid crystalline material has a high dielectric anisotropy, for example a dielectric anisotropy of 10 or higher, 11 or higher, 12 or higher, 13 or higher, 14 or higher, or 15 or higher. In some embodiments, the liquid crystalline material has a dielectric anisotropy in a range from 10 to 15.

In some embodiments, the liquid crystalline material has a short haze clearing time, for example a haze clearing time of 1 sec or less, 950 msec or less, 900 msec or less, 850 msec or less, 800 msec or less, 750 msec or less, 700 msec or less, 650 msec or less, 600 msec or less, 550 msec or less, 500 msec or less, 450 msec or less, 400 msec or less, 350 msec or less, 300 msec or less, 250 msec or less, 200 msec or less, 150 msec or less, 100 msec or less, 50 msec or less, or 10 msec or less. In some embodiments, the liquid crystalline material has a haze clearing time in a range from 10 msec to 1 sec, preferably in a range from 450 msec to 600 msec. The haze clearing time is the rate of clearing of cloudiness or haze after the lens is switched off.

In some embodiments, the liquid crystalline material has a fast switching time, for example a switching time of 5 msec or less, 4.5 msec or less, 4 msec or less, 3.5 msec or less, 3 msec or less or 2.5 msec or less. In some embodiments, the liquid crystalline material has a switching time in a range from 2.5 msec to 5 msec. The switching time is the time it takes the liquid crystalline material to switch between states (i.e., activated and deactivated).

In some embodiments, the amount of applied voltage required to switch the liquid crystalline material between the activated and deactivated states is low. For example, the liquid crystalline material switches at an applied voltage of 12 V or less, 11.5 V or less, 11 V or less, 10.5 V or less, 10 V or less, 9.5 V or less, 9 V or less, 8.5 V or less, 8 V or less, 7.5 V or less, 7 V or less, 6.5 V or less, 6 V or less, 5.5 V or less, 5 V or less, 4.5 V or less, 4 V or less, 3.5 V or less, 3 V or less, 2.5 V or less, or 2 V or less. In some embodiments, the liquid crystalline material switches at an applied voltage in a range from 2 V to 12 V, preferably in a range from 5 V to 8 V.

In some embodiments, the liquid crystalline mixture has a low static haze, for example a static haze of 2% or less, 1.9% or less, 1.8% or less, 1.7% or less, 1.6% or less, 1.5% or less, 1.4% or less, 1.3% or less, 1.2% or less, 1.1% or less, 1% or less, 0.9% or less, 0.8% or less, 0.7% or less, 0.6% or less, 0.5% or less, 0.4% or less, 0.3% or less, 0.2% or less, or 0.1% or less. In some embodiments, the liquid crystalline mixture has a static haze in a range from 0.1% to 2%, preferably in a range from 1% to 1.3%. The static haze can be measured using a standard haze meter.

In some embodiments, one of more of the rotational viscosity, dielectric anisotropy, haze clearing time, switching time, applied voltage required for switching, and static haze of the liquid crystalline mixture falls within any of the ranges specified above for each of these parameters. For example, the liquid crystalline material can: have a rotational viscosity of 50 mPa·s or less; have a dielectric anisotropy of 10 or higher; have a haze clearing time of 600 msec or less; have a switching time of 5 msec or less; switch at an applied voltage of 8 V or less; and have a static haze of 1.3% or less.

It should be further noted that the invention contemplates all ophthalmic lenses; contact lenses, intra-ocular lenses, corneal on-lays, corneal in-lays, and spectacle lenses. In some embodiments, the ophthalmic lenses can be the device. In other embodiments, the device can be a pair of spectacles including the ophthalmic lenses.

### Example

Three liquid crystalline mixtures were tested in an electro-active ophthalmic lens configuration similar to that illustrated in FIG. 7. The liquid crystalline mixtures were procured from DIC of Japan (referred to as LC1), Merck of Germany (referred to as LC2), and JNC Corporation of Japan (referred to as LC3) based on a request for a liquid crystalline mixture having a combination of the following properties: a rotational viscosity of 30 mPa·s or less, a dielectric anisotropy of 15 or greater, a birefringence of 0.26 or greater, an isotropic temperature of 100° C. or less, and having a nematic phase in a range from 0° C. to 100° C. LC1, LC2, and LC3 did not meet all of the specified properties. The composition of LC1, LC2, and LC3 were unknown and were not sold under a tradename. Table 1 below provides the extraordinary refractive index nₑ, ordinary refractive index nₒ, birefringence Δn, average refractive index n_{avg}, isotropic temperature T_{c}, dielectric anisotropy Δ∈, and flow viscosity η or rotational viscosity γ₁ of LC1, LC2, and LC3. The indices of refraction (extraordinary, ordinary, and average) were based on measurements taken at a wavelength of 589 nm.

TABLE 1
Properties of the liquid crystalline materials

| | | | | | | dielec. | viscosity, | |
|---|---|---|---|---|---|---|---|---|
| LC | ne | no | birefringence | n, avg | Tc, C. | anisot. | mPa · s | |
| LC 1 | 1.765 | 1.514 | 0.251 | 1.6395 | 99.4 | 16.2 | 50 | (flow) |
| LC 2 | 1.7779 | 1.5113 | 0.2666 | 1.6446 | 109 | 11.9 | 203 | (rotat) |
| LC 3 | 1.756 | 1.515 | 0.241 | 1.6355 | 91.4 | 11.8 | 31.7 | (rotat) |

The liquid crystalline mixtures tested were chosen with an average refractive index (n_{avg}) of approximately 1.64 so that they were a close match to the average refractive index (n_{avg}) of the first and second substrate materials of the lens, which was approximately 1.67. Multiple lenses were made with each liquid crystalline material and several parameters important for the operation of the electro-active lenses were measured. These parameters included the haze clearing time (HCT), switching time, switching voltage, diffraction efficiency, and static haze. Table 2 presents these measured values for the lenses made with LC1, LC2, and LC3.

TABLE 2
Properties of the tested lenses

| | | | | Diffraction | | Static |
|---|---|---|---|---|---|---|
| | HC T, | Switching | Driving | Efficiency, % | | Haze, |
| LC ID | msec | Time, msec | Voltage, V | On | Off | % |
| LC 1 | 983 | 3 | 10.24 | 94.4 | 5.37 | 1.76 |
| LC 1 | 1021 | 4 | 8.10 | 95.10 | 4.42 | 1.13 |
| LC 1 | 893 | 3 | 7.60 | 94.50 | 6.92 | 1.09 |
| LC 1 | 768 | 3 | 7.40 | 97.88 | 5.99 | 1.15 |
| LC 1 | 1221 | 3 | 6.84 | 98.31 | 6.70 | 1.68 |
| LC 1 | 869 | 2 | 7.26 | 96.62 | 5.81 | 1.53 |
| avg | 959.17 | 3.00 | 7.91 | 96.14 | 5.87 | 1.39 |
| stdev | 156.21 | 0.63 | 1.22 | 1.72 | 0.91 | 0.30 |
| LC 2 | 1068 | 9 | 10.64 | 93.54 | 3.70 | 1.93 |
| LC 2 | 1120 | 8.7 | 9.70 | 95.31 | 4.30 | 1.87 |
| LC 2 | 978 | 9.3 | 8.60 | 94.70 | 4.78 | 1.76 |
| LC 2 | 949 | 11 | 9.47 | 94.72 | 3.44 | 1.75 |
| LC 2 | 696 | 8 | 9.34 | 95.74 | 3.95 | 1.37 |
| avg | 962.20 | 9.20 | 9.55 | 94.80 | 4.03 | 1.74 |
| stdev | 163.85 | 1.12 | 0.74 | 0.83 | 0.52 | 0.22 |
| LC 3 | 565 | 2 | 5.69 | 97.30 | 916 | 1.16 |
| LC 3 | 392 | 3 | 5.79 | 98.00 | 9.74 | 0.93 |
| LC 3 | 469 | 3 | 5.90 | 98.60 | 8.02 | 1.25 |
| LC 3 | 401 | 3 | 5.82 | 98.08 | 8.90 | 0.89 |
| LC 3 | 453 | 3 | 6.31 | 95.42 | 8.40 | 1.13 |
| LC 3 | 472 | 3 | 5.93 | 97.47 | 9.70 | 1.19 |
| LC 3 | 367 | 4 | 6.50 | 97.34 | 8.46 | 1.10 |
| LC 3 | 549 | 3 | 5.90 | 98.17 | 9.40 | 1.01 |
| LC 3 | 562 | 3 | 6.39 | 98.04 | 9.34 | 1.03 |
| avg | 470.00 | 3.00 | 6.03 | 97.60 | 9.01 | 1.08 |
| stdev | 75.40 | 0.50 | 0.29 | 0.92 | 0.61 | 0.12 |

A summary of the measured parameters for LC1, LC2, and LC3 is provided in Table 3 below.

TABLE 3
Summary of the parameters of the liquid crystalline materials

| | | | | Diffraction | | Static |
|---|---|---|---|---|---|---|
| | HC T, | Switching | Driving | Efficiency, % | | Haze, |
| LC ID | msec | Time, msec | Voltage, V | On | Off | % |
| LC1 | 959.2 | 3 | 7.9 | 96.1 | 5.9 | 1.4 |
| LC2 | 962.2 | 9.2 | 9.6 | 94.8 | 4 | 1.7 |
| LC3 | 470.1 | 3 | 6 | 97.6 | 9 | 1.1 |

Table 3 shows that liquid crystalline materials having a low rotational viscosity (for example, less than 50 mPa·s), such as LC3, yielded electro-active ophthalmic lenses with the shortest haze clearing time (HCT). HCT was measured as the time needed for the transmittance in the electro-active zone, after the lens is turned off, to reach 95% of the initial lens transmittance (i.e. of the transmittance before the lens was turned on). Table 3 also shows that liquid crystalline materials having a low rotational viscosity, such as LC3, yielded electro-active ophthalmic lenses, had a faster switching time (the time to switch between the activated and deactivated states), as well as required lower voltage for switching. The static haze was acceptable firom the wearer's point of view.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A device comprising:
a lens comprising:
a progressive addition region having an add power;
an electro-active element in optical communication with the progressive addition region and having an activated state and a deactivated state, the electro-active element comprising:
a liquid crystalline material disposed in a cavity having a diffractive surface relief structure;
a first substrate having the diffractive surface relief structure; and
a second substrate;
wherein:
the liquid crystalline material has a first average index of refraction when the electro-active element is in the activated state and a second average index of refraction, different from the first average index of refraction, when the electro-active element is in the deactivated state;
a depth of the diffractive surface relief structure is from 1 micron to 10 microns;
the diffractive surface relief structure has an average index of refraction from 1.5 to 2;
the liquid crystalline material has a rotational viscosity of 50 mPa·s or less;
the liquid crystalline material has a dielectric anisotropy of 10 or higher;
the liquid crystalline material has a haze clearing time of 600 msec or less;
the liquid crystalline material has a switching time of 5 msec or less;
the liquid crystalline material switches at an applied voltage of 8 V or less;
the liquid crystalline mixture has a static haze of 1.3% or less;
at least the diffractive surface relief structure of the first substrate and the second substrate define a shape of the cavity;
the second average index of refraction of the liquid crystalline material is substantially the same as the average index of refraction of the diffractive surface relief structure;
the average index of refraction of the diffractive surface relief structure is from 1.5 to 1.8;
the device is a pair of spectacles; and
the electro-active element further comprises:
a first electrode disposed between the first substrate and the liquid crystalline material;
a second electrode disposed between the second substrate and the liquid crystalline material;
an insulation layer between the first and second electrodes; and
an alignment layer disposed on at least one of the first and second electrodes.
